(19) United States
(12) Patent Application Publication
(10) Pub. No.: US 2009/0097804 A1
(43) Pub. Date: Apr. 16, 2009

(54) Optical subassembly of optical semiconductor device module and assembly method thereof

(75) Inventor: Wen-Ping Yu, Taipei County (TW)

Correspondence Address: REED SMITH LLP, Suite 1400, 3110 Fairview Park Drive, Falls Church, VA, 22042, US

(73) Assignee: Amtran Technology Co., Ltd.

(21) Appl. No.: 12/010,598

(22) Filed: Jan. 28, 2008

(30) Foreign Application Priority Data
Oct. 12, 2007 (TW) 096138105

(51) Int. Cl. G02B 6/36

(52) U.S. Cl. 385/90; 385/88

(57) ABSTRACT

The present invention provides an optical subassembly and the assembly method thereof. The optical subassembly includes a first base, an optical fiber module, a first optical semiconductor device module, and a second optical semiconductor device module. The optical fiber module includes an optical fiber. The first optical semiconductor device module includes at least one first optical semiconductor device. The second optical semiconductor device module includes a second base and at least one second optical semiconductor device. The method according to the invention mounts the optical fiber module on the first base, mounts the at least one first optical semiconductor device on the first base, mounts the at least one second optical semiconductor device on the second base, substantially aligns the second optical semiconductor device module to the optical fiber, and bonds the second base to the first base.

### BACKGROUND OF THE INVENTION

1. Field of the Invention

The invention relates to an optical subassembly of an optical semiconductor device module and the assembly method thereof, and more particularly, to an optical semiconductor device module with a separated base and the assembly method thereof.

2. Description of the Prior Art

Optical subassemblies (OSA) in an optical communication system can be classified as transmitter optical subassemblies (TOSA) or receiver optical subassemblies (ROSA) according to devices with different functions. The transmitter optical subassemblies are capable of optically coupling laser diodes or light emitting diodes to an optical fiber, such that electrical signals can be transformed to light signals and be focused by lens to be transmitted in the optical fiber.

In prior arts, the assembling method of optical subassemblies is to align optical devices on a base in order and then get them fixed. The method of testing and adjustment during or after the assembling is to adjust the positions of the optical devices by the coupling factor of optical fiber. That is to say, after the assembling of the optical devices, the testing instrument at the end of the optical fiber adjusts the positions of the optical devices by the coupling factor of optical fiber, so as to accomplish a qualified product (referring to the specification about “Launched power distribution measurement procedure for graded-index multi-mode fiber transmitters” in TIA/EIA-455-203 of International Telecommunication Society). In another word, the testing procedures of determining whether or not the optical path is open must be offered after assembling all optical devices on one base.

However, in practical operations, because the sizes of the optical devices are rather small, assembling or bonding the optical devices after aligning the positions of the optical devices may cause errors. Moreover, the optical coupling is usually required of higher accuracy. Therefore, if the testing result of the optical path turns out to be not open after assembling, it will be difficult to determine that the problem is caused by which one of the optical devices. Also, the problem may be induced by many optical devices which generate errors and get interacted. As a result, the cycle time of manufacturing and the cost are necessarily increased in order to find out the optical devices with problems and to adjust them one by one.

Accordingly, the scope of the invention is to provide an optical subassembly and the assembly method thereof. With the structure having a separated base and the assembly method, the optical subassembly can be easily assembled and the time of adjusting the optical path can be reduced, so as to avoid assembling mistakes and increase assembling efficiency.

### SUMMARY OF THE INVENTION

The optical subassembly according to a preferred embodiment of the invention includes a first base, an optical fiber module, a first optical semiconductor device module, and a second optical semiconductor device module. The optical fiber module is mounted on the first base. The optical fiber module includes an optical fiber which has a first optical axis. The first optical semiconductor device module includes at least one first optical semiconductor device which has a respective first optical path. The at least one first optical semiconductor device is mounted on the first base, such that the at least one first optical path is optically coupled to the first optical axis. The second optical semiconductor device module includes a second base and at least one second optical semiconductor device which has a respective second optical path. A second optical axis is defined based on the second base. The at least one second optical semiconductor device is mounted on the second base, such that the at least one second optical path is optically coupled to the second optical axis. The second optical semiconductor device module is substantially aligned to the optical fiber, such that the second optical axis is optically coupled to the first optical axis. After the second optical axis is optically coupled to the first optical axis, the second base is boned to the first base.

Furthermore, according to the method of assembling an optical subassembly of a preferred embodiment of the invention, the optical subassembly includes a first base, an optical fiber module, a first optical semiconductor device module, and a second optical semiconductor device module. The optical fiber module includes an optical fiber which has a first optical axis. The first optical semiconductor device module includes at least one first optical semiconductor device which has a respective first optical path. The second optical semiconductor device module includes a second base and at least one second optical semiconductor device which has a respective second optical path. A second optical axis is defined based on the second base. First, the method includes the step of mounting the optical fiber module on the first base. And, the method includes the step of mounting the at least one first optical semiconductor device on the first base, such that the at least one first optical path is optically coupled to the first optical axis. Then, the method includes the step of mounting the at least one second optical semiconductor device on the second base, such that the at least one second optical path is optically coupled to the second optical axis. Subsequently, the method includes the step of substantially aligning the second optical semiconductor device module to the optical fiber, such that the second optical axis is optically coupled to the first optical fiber. Finally, the method includes the step of bonding the second base to the first base after the second optical axis is optically coupled to the first optical axis.

Accordingly, the scope of the invention is to provide an optical subassembly and the assembly method thereof. With the structure having a separated base and the assembly method, the optical subassembly can be easily assembled and the time of adjusting the optical path can be reduced, so as to avoid assembling mistakes and increase assembling efficiency. The advantage and spirit of the invention may be understood by the following recitations together with the appended drawings.

### BRIEF DESCRIPTION OF THE APPENDED DRAWINGS

FIG. 1A is a schematic diagram illustrating an optical subassembly according to a preferred embodiment of the invention.

FIG. 1B is a top view of the optical subassembly in FIG. 1A.

FIG. 1C is a schematic diagram illustrating the optical subassembly in FIG. 1A completely assembled.

FIG. 2 is a top view of a first optical semiconductor device module according to another preferred embodiment of the invention.

FIG. 3 is a flow chart diagram showing a method of assembling the optical subassembly according to a preferred embodiment of the invention.

### DETAILED DESCRIPTION OF THE INVENTION

The scope of the invention is to provide an optical subassembly and the assembly method thereof. The spirit and feature of the present invention will be described in detail by the following preferred embodiments.

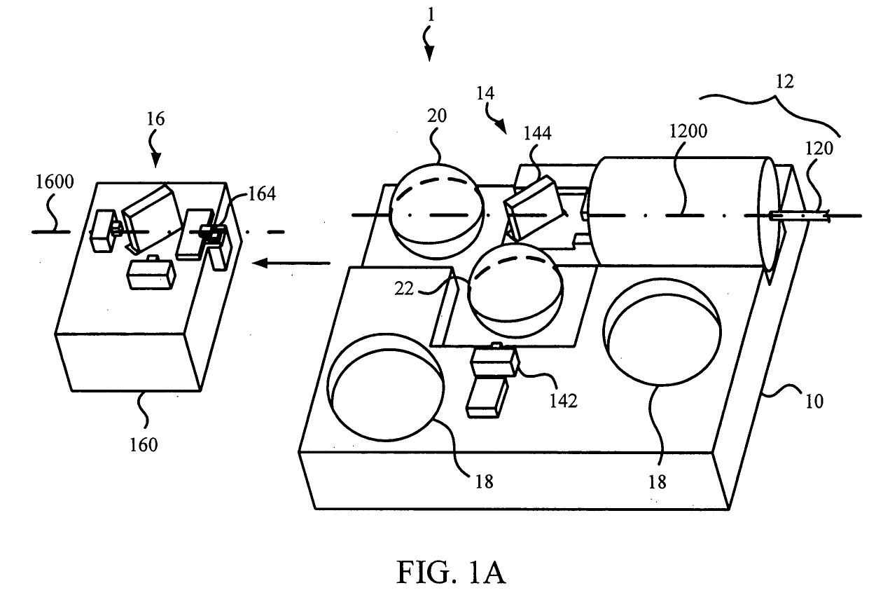

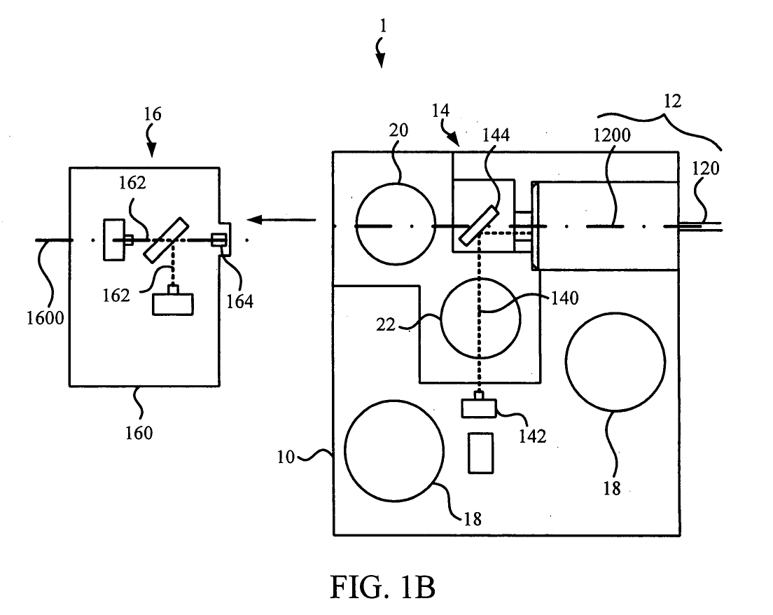

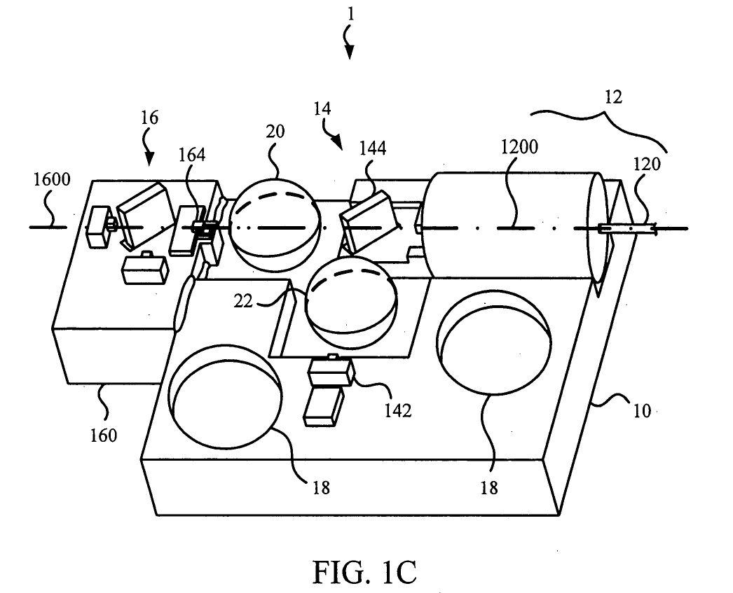

Please refer to FIG. 1A and FIG. 1B. FIG. 1A is a schematic diagram illustrating an optical subassembly according to a preferred embodiment of the invention. FIG. 1B is a top view of the optical subassembly 1 in FIG. 1A. As shown in FIG. 1A and FIG. 1B, the optical subassembly 1 includes a first base 10, an optical fiber module 12, a first optical semiconductor device module 14, and a second optical semiconductor device module 16.

As shown in FIG. 1A and FIG. 1B, the optical fiber module 12 is mounted on the first base 10. The optical fiber module 12 includes an optical fiber 120 which has a first optical axis 1200. The first optical semiconductor device module 14 includes at least one first optical semiconductor device which has a respective first optical path 140. The at least one first optical semiconductor device is mounted on the first base 10, such that the at least one first optical path 140 is optically coupled to the first optical axis 1200.

As shown in FIG. 1A and FIG. 1B, the second optical semiconductor device module 16 includes a second base 160 and at least one second optical semiconductor device which has a respective second optical path 162. A second optical axis 1600 is defined based on the second base 160. The at least one second optical semiconductor device is mounted on the second base 160, such that the at least one second optical path 162 is optically coupled to the second optical axis 1600.

Please refer to FIG. 1C. FIG. 1C is a schematic diagram illustrating the optical subassembly 1 in FIG. 1A completely assembled. As shown in FIG. 1C, the second optical semiconductor device module 16 is substantially aligned to the optical fiber 120, such that after the second optical axis 1600 is optically coupled to the first optical axis 1200, the second base 160 is then boned to the first base 10.

As shown in FIG. 1A and FIG. 1B, in an embodiment, the optical subassembly 1 further includes at least one magnetic-inductive device 18. The at least one magnetic-inductive device 18 is mounted on the first base 10. The at least one magnetic-inductive device 18 is capable of being attracted by at least one electro-magnetic device (not shown in figure) of an auxiliary aligning machine during the alignment of the second optical semiconductor device module 16 to the optical fiber 120.

It is notable that the at least one electromagnetic device generates magnetic force to attract the at least one magnetic-inductive device 18 by being electrified. On the contrary, the at least one electromagnetic device releases the at least one magnetic-inductive device 18 after cutting off the power supply. Hereby, the auxiliary aligning machine is capable of aligning. Therefore, the magnetic-inductive device 18 can not be replaced by a permanent magnet, or the action of attracting and releasing can not be achieved. In a practical application, the accuracy of operation of the auxiliary aligning machine is generally within a range between 40 nm and 60 nm.

As shown in FIG. 1A and FIG. 1B, in an embodiment, the at least one second optical semiconductor device includes at least one light emitter 164 for generating, by driven, at least one forward light signal. In a practical application, in order to increase the amount of data to be transmitted, the transmitter optical subassembly 1 within an optical communication system can applies two, three, or more than four light emitters in a bidirectional symmetrical transmit mode or in a bidirectional asymmetrical mode.

Also shown in FIG. 1A and FIG. 1B, in the embodiment, the optical subassembly 1 further includes a first lens module 20. The first lens module 20 is mounted on the first base 10 and at the first optical axis 1200. The first lens module 20 is used for congregating the at least one forward light signal to get into a facet of the optical fiber 120.

Also shown in FIG. 1A and FIG. 1B, in the embodiment, the optical subassembly 1 further includes at least one second lens module 22. Each second lens module 22 corresponds to one first optical path 140 of the at least one first optical path 140. Each second lens module 22 is mounted on the first base 10 and at the corresponding first optical path 140. Each second lens module 22 is used for congregating one of the at least one backward light signal to get into a corresponding photodetector 142.

It is notable that the first optical semiconductor device module 14 and the second optical semiconductor device module 16 can be assembled with high accuracy respectively. Therefore, the first optical semiconductor device module 14 and the second optical semiconductor device module 16 can be assembled individually before aligning the optical path. As long as the light signal can be detected to pass the optical fiber 120 during the aligning of the optical path, the optical subassembly 1 is successfully assembled.

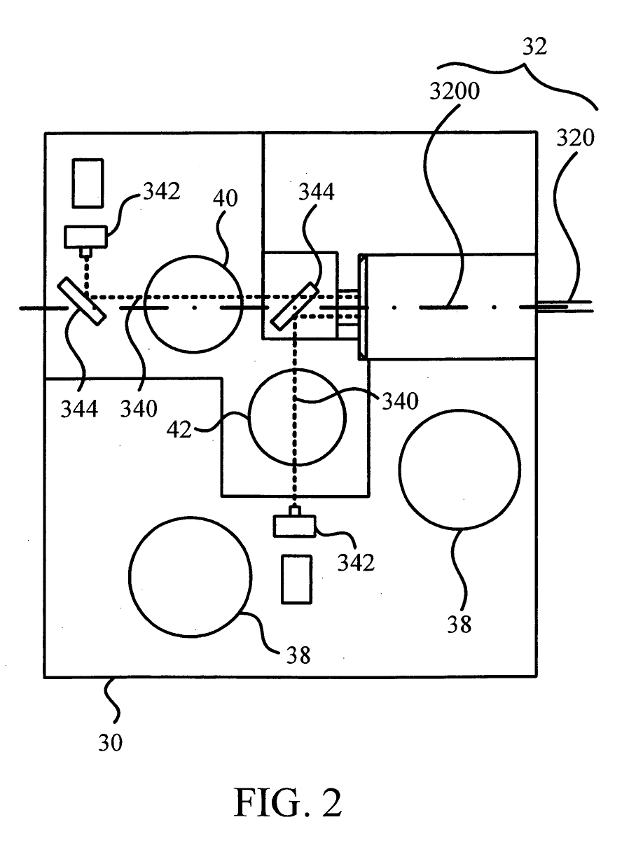

Please refer to FIG. 2. FIG. 2 is a top view of a first optical semiconductor device module 34 according to another preferred embodiment of the invention. In order to receive a great deal of data transmitted by a plurality of light emitters, the receiver optical subassembly 1 within an optical communication system can include a plurality of photodetectors and wavelength selective filters because of the quantity of adopted light emitters.

Consequently, as shown in FIG. 2, in an embodiment, the at least one first optical semiconductor device includes at least one photodetector 342 and at least one wavelength selective filter 344. Each photodetector 342 is mounted on the first base 30 at a corresponding first optical path 340. Each wavelength selective filter 344 corresponds to one of the at least one photodetector 342. Each wavelength selective filter 344 is mounted on the first base 30 and at the first optical axis 3200. Each wavelength selective filter 344 is optically coupled to the optical fiber 320 and the corresponding photodetector 342, and is for reflecting one of the at least one backward light signal transmitted over the optical fiber 320 to the corresponding photodetector 342.

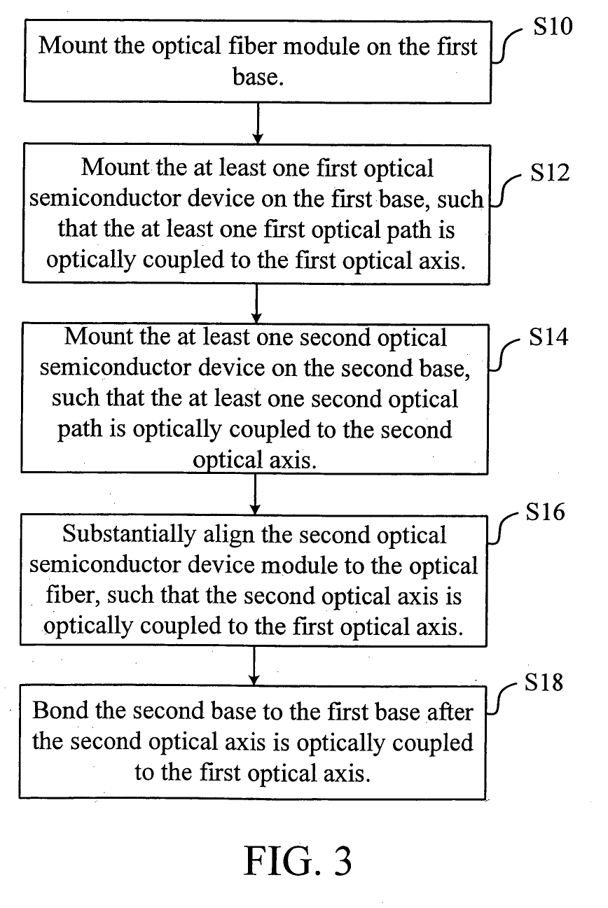

Please refer to FIG. 3. FIG. 3 is a flow chart diagram showing a method of assembling the optical subassembly 1 according to a preferred embodiment of the invention. The method applies the optical subassembly 1 as shown in FIG. 1A and FIG. 1B. The method includes the steps as following.

First, the method performs step S10: mounting the optical fiber module 12 on the first base 10.

Then, the method performs step S12: mounting the at least one first optical semiconductor device on the first base 10, such that the at least one first optical path 140 is optically coupled to the first optical axis 1200.

Next, the method performs step S14: mounting the at least one second optical semiconductor device on the second base 160, such that the at least one second optical path 162 is optically coupled to the second optical axis 1600.

After that, the method performs step S16: substantially aligning the second optical semiconductor device module 16 to the optical fiber 120, such that the second optical axis 1600 is optically coupled to the first optical axis 1200.

Finally, the method performs step S18: bonding the second base 160 to the first base 10 after the second optical axis 1600 is optically coupled to the first optical axis 1200.

In an embodiment, step S16 is performed via an auxiliary aligning machine. The optical subassembly 1 further includes at least one magnetic-inductive device 18. The at least one magnetic-inductive device 18 is mounted on the first base 10, and is capable of being attracted by at least one electromagnetic device of the auxiliary aligning machine during the alignment of the second optical semiconductor device module 16 to the optical fiber 120.

Compared with prior arts, it is obviously that according to the optical subassembly and the assembly method thereof of the invention, with the structure having a separated base and the assembly method, the optical subassembly can be easily assembled and the time of adjusting the optical path can be reduced, so as to avoid assembling mistakes and increase assembling efficiency. Moreover, the optical subassembly and the assembly method thereof can be applied to the transmitter optical subassembly and the receiver optical subassembly within an optical communication system.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An optical subassembly, comprising:
a first base;
an optical fiber module, mounted on the first base, comprising an optical fiber having a first optical axis;
a first optical semiconductor device module comprising at least one first optical semiconductor device which is mounted on the first base and has a respective first optical path, such that the at least one first optical path is optically coupled to the first optical axis; and
a second optical semiconductor device module comprising a second base and at least one second optical semiconductor device which is mounted on the second base and has a respective second optical path, a second optical axis being defined based on the second base, such that the at least one second optical path is optically coupled to the second optical axis, the second optical axis then being optically coupled to the first optical axis, and the second base being bonded to the first base afterwards.

2. The optical subassembly of claim 1, further comprising at least one magnetic-inductive device, mounted on the first base, capable of being attracted by at least one electro-magnetic device of an auxiliary aligning machine during the alignment of the second optical semiconductor device module to the optical fiber.

3. The optical subassembly of claim 1, wherein the at least one second optical semiconductor device comprises at least one light emitter for generating, by driven, at least one forward light signal.

4. The optical subassembly of claim 3, further comprising a first lens module, mounted on the first base and at the first optical axis, for congregating the at least one forward light signal to get into a facet of the optical fiber.

5. The optical subassembly of claim 4, wherein the at least one first optical semiconductor device comprises:
at least one photodetector which corresponds to one of the at least one first optical path and is mounted on the first base and at the corresponding first optical path; and
at least one wavelength selective filter which corresponds to one of the at least one photodetector, is mounted on the first base and at the first optical axis, is optically coupled to the optical fiber and the corresponding photodetector, and is for reflecting one of at least one backward light signal transmitted over the optical fiber to the corresponding photodetector.

6. The optical subassembly of claim 5, further comprising at least one second lens module which corresponds to one of the at least one first optical path, is mounted on the first base and at the corresponding first optical path, and is for focusing one of at least one backward light signal to the corresponding photodetector.

7. A method of assembling an optical subassembly comprising a first base, an optical fiber module comprising an optical fiber having a first optical axis, a first optical semiconductor device module comprising at least one first optical semiconductor device which has a respective first optical path, and a second optical semiconductor device module comprising a second base and at least one second optical semiconductor device which has a respective second optical path, a second optical axis being defined based on the second base, said method comprising the steps of:
(a) mounting the optical fiber module on the first base;
(b) mounting the at least one first optical semiconductor device on the first base, such that the at least one first optical path is optically coupled to the first optical axis;
(c) mounting the at least one second optical semiconductor device on the second base, such that the at least one second optical path is optically coupled to the second optical axis;
(d) substantially aligning the second optical semiconductor device module to the optical fiber, such that the second optical axis is optically coupled to the first optical axis; and
(e) bonding the second base to the first base after the second optical axis is optically coupled to the first optical axis.

8. The method of claim 7, wherein step (d) is performed via an auxiliary aligning machine, said optical subassembly further comprises at least one magnetic-inductive device, mounted on the first base, capable of being attracted by at least one electro-magnetic device of the auxiliary aligning machine during the alignment of the second optical semiconductor device module to the optical fiber.

9. The method of claim 7, wherein the at least one second optical semiconductor device comprises at least one light emitter for generating, by driven, at least one forward light signal.

10. The method of claim 9, wherein said optical subassembly further comprises a first lens module, mounted on the first base and at the first optical axis, for congregating the at least one forward light signal to get into a facet of the optical fiber.

11. The method of claim 10, wherein the at least one first optical semiconductor device comprises:
at least one photodetector which each corresponds to one of the at least one first optical path and is mounted on the first base and at the corresponding first optical path; and
at least one wavelength selective filter which each corresponds to one of the at least one photodetector, is mounted on the first base and at the first optical axis, is optically coupled to the optical fiber and the corresponding photodetector, and is for reflecting one of at least one backward light signal transmitted over the optical fiber to the corresponding photodetector.

12. The method of claim 11, wherein said optical subassembly further comprising at least one second lens module which corresponds to one of the at least one first optical path, is mounted on the first base and at the corresponding first optical path, and is for focusing one of at least one backward light signal to the corresponding photodetector.

13. The optical subassembly of claim 3, wherein the at least one second optical semiconductor device comprises:
at least one photodetector which corresponds to one of the at least one second optical path and is mounted on the second base and at the corresponding second optical path; and
at least one wavelength selective filter which corresponds to one of the at least one photodetector, is mounted on the second base and at the second optical axis, is optically coupled to the at least one light emitter and the corresponding photodetector, and is for reflecting one of the at least one forward light signal, generated by the light emitter, to the corresponding photodetector.

14. The method of claim 9, wherein the at least one second optical semiconductor device comprises:
at least one photodetector which corresponds to one of the at least one second optical path and is mounted on the second base and at the corresponding second optical path; and
at least one wavelength selective filter which corresponds to one of the at least one photodetector, is mounted on the second base and at the second optical axis, is optically coupled to the at least one light emitter and the corresponding photodetector, and is for reflecting one of the at least one forward light signal, generated by the light emitter, to the corresponding photodetector.
